(19) United States
(12) Patent Application Publication
(10) Pub. No.: US 2025/0093866 A1
(43) Pub. Date: Mar. 20, 2025

(54) PREDICTIVE MAINTENANCE SYSTEM AND AN IMPLEMENTATION METHOD THEREOF

(71) Applicant: Ennoconn Corporation, New Taipei City (TW)

(72) Inventors: JEN-HUA FANG, New Taipei City (TW); Chih-Jen Tsai, New Taipei City (TW); Chi-Kun Chen, New Taipei City (TW); Ting-Yun Shiue, New Taipei City (TW)

(21) Appl. No.: 18/794,493

(22) Filed: Aug. 5, 2024

(30) Foreign Application Priority Data
Sep. 15, 2023 (TW) 112135407

(51) Int. Cl. G05B 23/02

(52) U.S. Cl. CPC G05B 23/0283

(57) ABSTRACT

A predictive maintenance system and an implementation method thereof are provided. The system includes a mainboard, a sensing interface card coupled to the mainboard, and a predictive maintenance program. The mainboard includes a storage for storing a computer program and one or more processors for executing the computer program. The sensing interface card includes a sensor connection port that is configured to connect external device sensors with different connection interfaces and to receive detection values detected by the external device sensors, and a microprocessor for receiving the detection values to generate a failure prediction analysis result. The predictive maintenance program stored in the storage is executed by the processors. The method includes generating a component service life information based on the failure prediction analysis result, obtaining a warning information based on the component service life information, and displaying the warning information on an alert management interface through the mainboard.

### CROSS-REFERENCE TO RELATED APPLICATION(S)

The present application claims the benefit of and priority to Taiwan Patent Application Serial No. 112135407, filed on Sep. 15, 2023, the contents of which are hereby incorporated herein fully by reference into the present application for all purposes.

### FIELD

The present disclosure generally relates to a field of predictive maintenance of machines and, more particularly, to a system for predicting the expiration of the life of components inside a machine.

### BACKGROUND

In recent years, the machine industry has been advancing towards the fields of intelligence and automation. Smart machine tools require intelligent monitoring functions to optimize processes, reduce production costs, enhance processing efficiency, and improve product quality. This results in significantly reduced mental and labor requirements for operators. Therefore, various industries have been focusing on developing remote monitoring capabilities for machine tools to shorten the distance between clients and processing sites and reduce the time taken to address machine tool issues.

Currently, traditional approaches to machine tool monitoring management include manual monitoring and management and single-channel signal acquisition technology. Manual monitoring and management involve monitoring and recording machine tool activities manually through human intervention. However, this approach still introduces errors due to human operation and incurs substantial labor costs. Single-channel signal acquisition technology involves transmitting data through a single channel, and utilizing single-core wires for transmission. Various types of sensors are directly connected to an individual acquisition device, thus enabling real-time monitoring of the status of the machine tool. Although this method achieves real-time monitoring, it requires the installation of multiple acquisition devices. This factor leads to increased device installation, maintenance, and overall costs. Additionally, it does not account for the proportional expansion of multiple machine tools, making maintenance more challenging.

Therefore, it is evident that the existing single-channel signal acquisition technology for machine tools still requires extensive research and improvement efforts.

### SUMMARY

In a first aspect of the present disclosure, a predictive maintenance system is provided. The predictive maintenance system includes a mainboard, a sensing interface card, and a predictive maintenance program. The main board includes: a storage that is configured to store a computer program including instructions to be executed; and one or more processors that are configured to execute the instructions of the computer program. The sensing interface card is coupled to the mainboard and includes: at least one sensor connection port that is configured to connect a plurality of external device sensors with different connection interfaces, and to receive a plurality of detection values that are detected by the plurality of external device sensors; and a microprocessor that is configured to receive the detection values to generate a failure prediction analysis result. The predictive maintenance program including instructions are stored in the storage. When the instructions of the predictive maintenance program are executed by the one or more processors, the one or more processors are further configured to: generate component service life information based on the failure prediction analysis result; obtain warning information based on the component service life information; and display the warning information on an alert management interface through the mainboard.

In another implementation of the first aspect, the storage further stores a system risk prediction algorithm, and the failure prediction analysis result is calculated and generated based on the plurality of detection values and the system risk prediction algorithm.

In another implementation of the first aspect, the predictive maintenance program further comprises a plurality of component service life algorithms, and the component service life information is generated based on the failure prediction analysis result and the plurality of component service life algorithms.

In another implementation of the first aspect, the predictive maintenance program further comprises an information transmission module configured to transmit the warning information through an email or an instant messaging system.

In another implementation of the first aspect, the sensing interface card further includes at least one environmental sensor, and the at least one environmental sensor is configured to sense various environmental parameter information inside a host where the sensing interface card is installed.

In a second aspect of the present disclosure, an implementation method of a predictive maintenance system is provided. An implementation method of a predictive maintenance system includes: receives external information, by at least one sensor connection port of a sensing interface card, including receiving a plurality of detection values of a plurality of external device sensors; compares and analyzes, by a microprocessor, the plurality of detection values and generating a failure prediction analysis result; analyzes the failure prediction analysis result to determine and generate component service life information, generates warning information based on the component service life information, and displays the warning information on an alert management interface, by a processor executing a predictive maintenance program including instructions; and displays, by an external monitoring device, the alert management interface through an internet connection, such that a health status of an external device is monitored through the alert management interface.

In another implementation of the second aspect, the sensing interface card comprises a database, the database stores a plurality of component service life data, and the microprocessor further generates the failure prediction analysis result after comparing and analyzing the plurality of component service life data and the plurality of detection values.

In another implementation of the second aspect, the sensing interface card includes a plurality of environmental sensors, when the at least one sensor connection port of the sensing interface card receives the plurality of detection values of the plurality of external device sensors, the plurality of environment sensors simultaneously receive environmental parameter information inside a host where the sensing interface card is installed, and the sensing interface card further analyzes and compares the environmental parameter information and the plurality of detection values.

In another implementation of the second aspect, the failure prediction analysis result is processed with a data security encryption and uploaded to a cloud server platform for a backup.

In another implementation of the second aspect, the data security encryption is performed through an Advanced Encryption Standard (AES) encryption mechanism for data transmission.

### BRIEF DESCRIPTION OF THE DRAWINGS

FIG. 1 illustrates a schematic diagram of a system in accordance with an example implementation of the present disclosure.

FIG. 2 illustrates a schematic diagram of a connection with an external device in accordance with an example implementation of the present disclosure.

FIG. 3 illustrates an operational schematic diagram of a predictive maintenance program in accordance with an example implementation of the present disclosure.

FIG. 4 illustrates a flowchart of an implementation method in accordance with an example implementation of the present disclosure.

FIG. 5 illustrates a flowchart of an external information reception in accordance with an example implementation of the present disclosure.

FIG. 6 illustrates a flowchart of a comparative analysis in accordance with an example implementation of the present disclosure.

FIG. 7 illustrates a flowchart of a failure determination in accordance with an example implementation of the present disclosure.

### DETAILED DESCRIPTION

The following disclosure contains specific information pertaining to exemplary implementations in the present disclosure. The drawings in the present disclosure and their accompanying detailed disclosure are directed to merely exemplary implementations. However, the present disclosure is not limited to merely these exemplary implementations. Other variations and implementations of the present disclosure will occur to those skilled in the art. Unless noted otherwise, like or corresponding components among the figures may be indicated by like or corresponding reference numerals. Moreover, the drawings and illustrations in the present disclosure are generally not to scale and are not intended to correspond to actual relative dimensions.

For the purposes of consistency and ease of understanding, like features are identified (although, in some examples, not shown) by numerals in the exemplary figures. However, the features in different implementations may be different in other respects, and thus shall not be narrowly confined to what is shown in the figures.

The disclosure uses the phrases “in one implementation,” “in some implementations,” and so on, which may each refer to one or more of the same or different implementations. The term “coupled” is defined as connected, directly, or indirectly through intervening components, and is not necessarily limited to physical connections. The term “comprising” means “including, but not necessarily limited to;” it specifically indicates open-ended inclusion or membership in the so-described combination, group, series, and the equivalent.

Additionally, for the purposes of explanation and non-limitation, specific details, such as functional entities, techniques, protocols, standards, and the like, are set forth for providing an understanding of the described technology. In other examples, detailed disclosure of well-known methods, technologies, systems, architectures, and the like are omitted so as not to obscure the disclosure with unnecessary details.

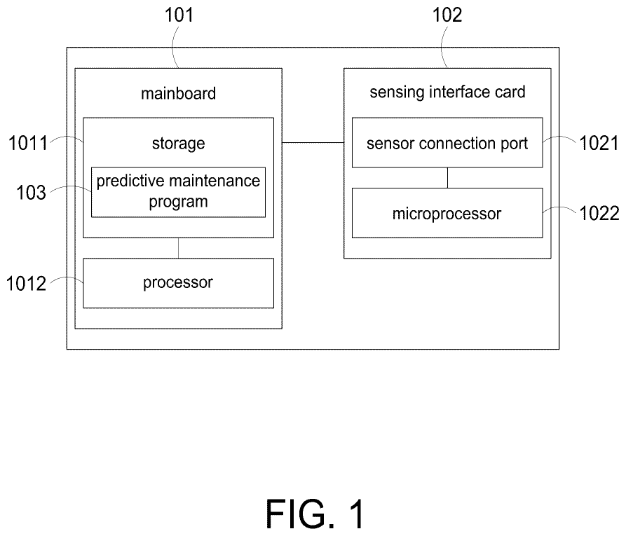

FIG. 1 illustrates a schematic diagram of a system in accordance with an example implementation of the present disclosure. A predictive maintenance system 10 of the present disclosure primarily includes a mainboard 101, a sensing interface card 102, and a predictive maintenance program 103. The mainboard 101 includes a storage 1011 and a processor 1012. The storage 1011 is configured to store a computer program including instructions to be executed. The storage 1011 may serve as a database or a memory structure capable of storing a plurality of computer programs. The predictive maintenance program 103 including instructions that are stored in the storage 1011. The processor 1012 is responsible for executing the instructions of the computer program and the processor 1012 may be a general-purpose processor, micro-control unit (MCU), application processor (AP), digital signal processor (DSP), graphics processing unit (GPU), holographic processing unit (HPU), neural processing unit (NPU), or any similar component. The processor 1012 includes various logic circuits to provide the mainboard 101 with data processing and computational capabilities to execute the instructions of the computer program. When the instructions of the computer programs stored in the storage 1011 are executed by the processor 1012, not all of them necessarily run simultaneously. It is possible to select one or a plurality of computer programs for execution, and the executed computer programs may run in the background of the operating system (OS).

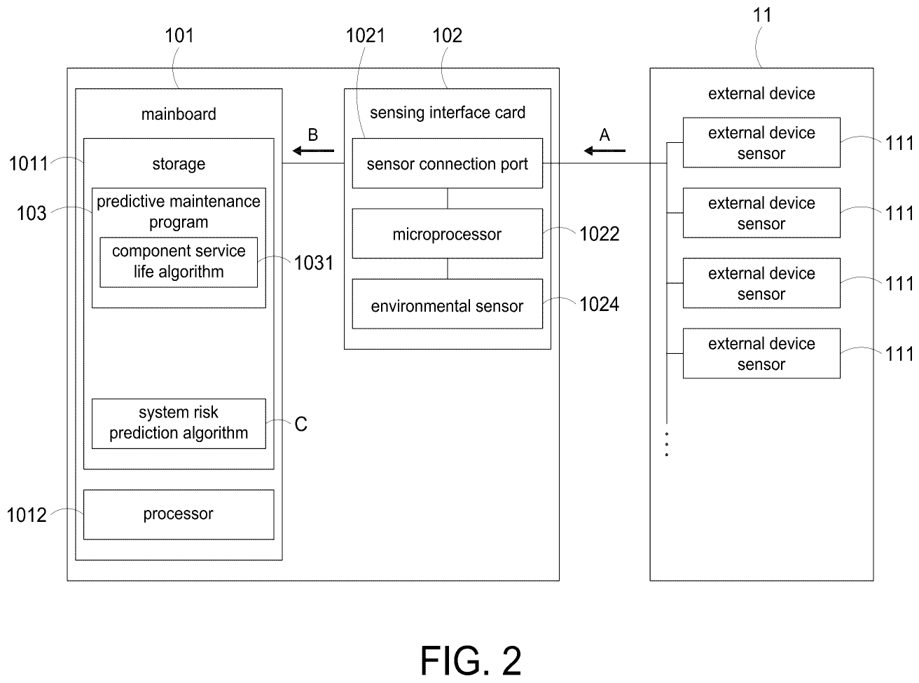

With reference to FIG. 2. FIG. 2 illustrates a schematic diagram of a connection with an external device in accordance with an example implementation of the present disclosure. The sensing interface card 102 is coupled to the mainboard 101. The sensing interface card 102 may have a PCI Express (PCIe) or any other interface that may be coupled to the mainboard 101. Additionally, the sensing interface card 102 may be coupled to the mainboard 101 through soldering wiring. The mentioned interface examples serve as an illustration and are not meant to limit the forms of the interface. The sensing interface card 102 includes at least one sensor connection port 1021 and a microprocessor 1022. The sensor connection port 1021 is configured to connect a plurality of external device sensors 111 with different connection interfaces of the external device 11 to receive a plurality of detection values A detected by the plurality of external device sensors 111. The sensor connection port 1021 includes diverse communication interfaces such as Universal Asynchronous Receiver/Transmitter (UART), Analog-to-Digital Converter (ADC), Inter-Integrated Circuit (I2C), RS485, and others. These interfaces are used to connect a plurality of external device sensors with a variety of different interfaces. The microprocessor 1022 is used to compare and analyze the plurality of detection values A to generate a failure prediction analysis result B. The failure prediction analysis result B is transmitted to the mainboard 101 for further processing. Furthermore, by performing pre-analysis and calculation on the plurality of detection values A through the microprocessor 1022, the generation of the failure prediction analysis result B may effectively reduce the computational load on the processor 1012.

In some implementations, the present disclosure provides an alternative method for generating the failure prediction analysis result B. Specifically, the storage 1011 stores a system risk prediction algorithm C. After the plurality of detection values A are received by the sensing interface card 102, the sensing interface card 102 does not process the plurality of detection values A, but instead transmits the plurality of detection values A to the mainboard 101. The plurality of detection values A are then processed by the system risk prediction algorithm C to generate the failure prediction analysis result B. The system risk prediction algorithm C mainly presets the red and yellow light warning conditions of the external device sensor based on application experiences. The yellow light warning condition may be a recommendation to schedule the replacement of a device, while the red light warning condition may be a recommendation to immediately replace the device. The value reading time of the system may be preset. For example, the system reads the plurality of detection values A from the plurality of external device sensors every 6 seconds, and determines whether a red and yellow light warning condition is generated (i.e., the failure prediction analysis result B). Users may use this information to judge whether device replacement is necessary. Furthermore, the system may also evaluate the risk score of an external device based on the number of red and yellow light warnings generated within a specific period. For instance, if the risk score is 0, the risk of damage is low, and if the risk score is 5, the risk of damage is high. Users may judge the device's condition based on the risk score to determine whether replacement is required.

In some implementations, the microprocessor 1022 may be an Acorn RISC Machine (ARM), MCU, or any other processor capable of computation. With reference to FIG. 2, in some implementations, the sensing interface card 102 includes at least one environment sensor 1024. These environmental sensors 1024 are used to sense various environmental parameters information inside the host where the sensing interface card 102 is installed, and the sensing interface card 102 conducts an analysis and comparison on the environmental parameter information that is inside the host, where the sensing interface card 102 is installed, with the plurality of detection values.

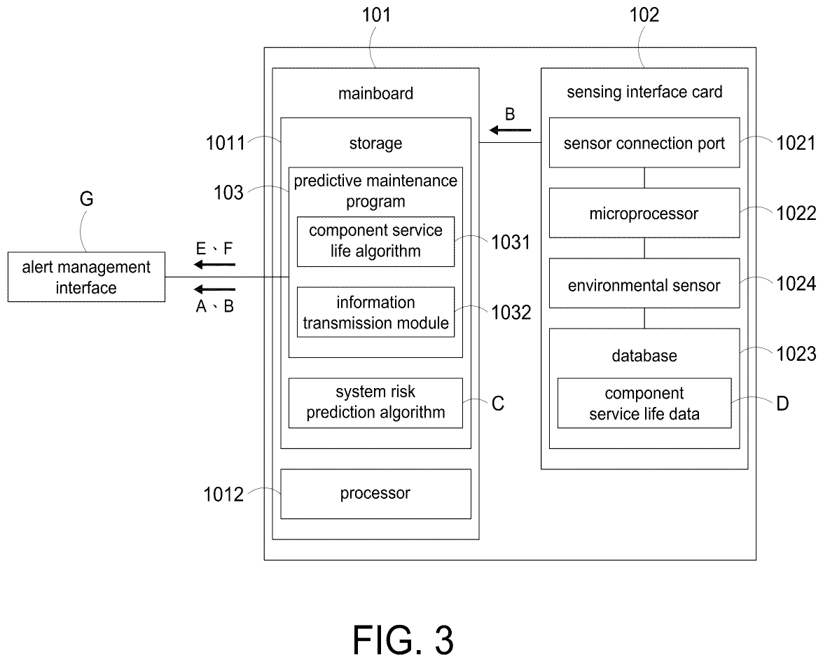

With reference to FIG. 3. FIG. 3 illustrates an operational schematic diagram of a predictive maintenance program in accordance with an example implementation of the present disclosure. The predictive maintenance program 103 is a computer program that includes instructions stored in the storage 1011. When the instructions of the predictive maintenance program 103 are executed by the processor 1012, the instructions of the predictive maintenance program 103 perform the following actions:
generate a component service life information F based on the failure prediction analysis result B;
obtain a warning information E based on the component service life information F; and
display the warning information E on an alert management interface G through the mainboard.

In some implementations, the predictive maintenance program 103 includes a plurality of component service life algorithms 1031. The component service life algorithms 1031 include PSU life prediction algorithms, fan life algorithms, mainboard life algorithms, etc. The failure prediction analysis result B generates the component service life information F according to the component service life algorithm 1031. The component service life algorithms 1031 primarily involve pre-investigating the Mean Time Between Failures (MTBF) values of various components, and store the MTBF value of each component in the microprocessor 1022, and set the temperature aging rate parameters. It is determined that each device component will accelerate aging due to the system ambient temperature. The user may set the aging rate of each device component according to the usage conditions. When calculating the remaining time, the temperature aging factor is deducted to obtain the service life value of the device component.

In some implementations, the predictive maintenance program 103 includes an information transmission module 1032 configured to transmit the warning information E through an email or an instant messaging system.

With reference to FIGS. 1, 2, and 3. In some implementations, the hardware interface of the sensing interface card 102 is a standardized interface. The user may uniformly couple the plurality of external device sensors to the sensing interface card 102 so that the sensing interface card 102 may receive the plurality of detection values from the plurality of external device sensors. The plurality of external device sensors may further include power supply monitors, mainboard hardware monitors, DC current sensors, DC voltage sensors, AC power meters, and other types of sensors. Since the interface of the sensing interface card 102 may be a standard PCIe interface and is compatible with most mainboards, the sensing interface card 102 may be applied to the mainboards of the hosts with different types, and the sensing interface card 102 has diversified communication interfaces to connect the plurality of external device sensors with different interfaces, so that the sensing interface card 102 has a wide range of industrial applications.

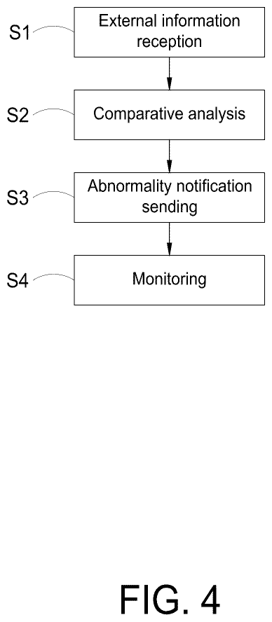

With reference to FIGS. 3 and 4. FIG. 4 illustrates a flowchart of an implementation method in accordance with an example implementation of the present disclosure. Please refer to FIGS. 1 to 3 together. The implementation method of the predictive maintenance system 10 of the present disclosure is as follows.

External information reception S1: The sensor connection port 1021 of the sensing interface card 102 is coupled to at least one external device sensor 111 of at least one external device 11. Under normal conditions, the sensing interface card 102 may receive a plurality of detection values A that is generated by the plurality of external device sensors 111 after detecting the internal components of the external device 11.

Comparative analysis S2: The microprocessor 1022 of the sensing interface card 102 compares and analyzes the plurality of detection values A and generates the failure prediction analysis result B. In some implementations, the sensing interface card 102 includes a database 1023. The database 1023 stores a plurality of component service life data D. The component service life data D of these components may be understood as the recommended service life cycle that is given by the original manufacturer to each of the several components that are used to form the external device 11 at the time of shipment from the factory. The microprocessor 1022 further generates the failure prediction analysis result B after the comparing and analyzing of the component service life data D and the plurality of detection values A. The failure prediction analysis result B mainly contains relevant information about the remaining service life of each component. In some implementations, the failure prediction analysis result B is additionally processed to a data security encryption and uploaded to a cloud server platform for a backup, and the data security encryption is performed through the Advanced Encryption Standard (AES) encryption mechanism for data transmission. Furthermore, the plurality of detection values A, the warning information E and the component service life information F may also be synchronized and conducted to a data security encryption and uploaded to a cloud server platform for a backup.

Abnormality notification sending S3: The predictive maintenance program 103 is a computer program that includes instructions stored in the storage 1011. When the instructions of the predictive maintenance program 103 are executed by the processor 1012, the processor 1012 is configured to generate a component service life information F based on the failure prediction analysis result B, and generates a warning information E based on the component service life information F. The component service life information F primarily provides the information regarding which component is nearing the end of its useful life. On the other hand, the warning information E is designed to alert users about specific internal components of the external device 11 that may be approaching the end of their useful life. The predictive maintenance program 103 displays the warning information E on the alert management interface G, and the alert management interface G is a user interface. Users may customize settings according to their needs. The predictive maintenance program 103 may display the plurality of detection values A, failure prediction analysis result B, warning information E, and component service life information F synchronously on the alert management interface G.

Monitoring S4: The predictive maintenance system 10 may couple to a cloud server platform to form information connection, periodically uploading relevant data, such as sensor readings and prediction results. An external monitoring device may connect to the cloud server platform via a network connection (wired or wireless) and display the relevant data on the alert management interface G. The external monitoring device may be a smartphone, tablet, laptop, desktop computer, or any other electronic device. Users may monitor the overall health status of the external device 11 through the alert management interface G of the external monitoring device. In some implementations, if the failure prediction analysis result B is abnormal, the predictive maintenance program 103 may send notifications to users. Notification methods may include email, instant messaging, and more.

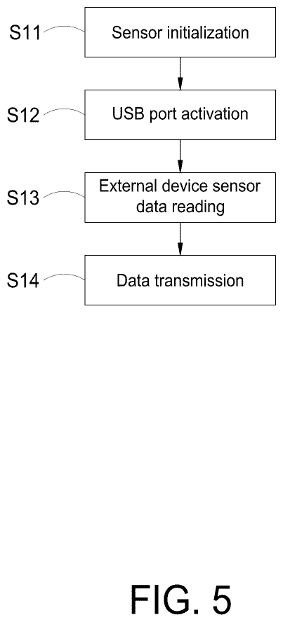

Please refer to FIG. 5 again. FIG. 5 illustrates a flowchart of an external information reception in accordance with an example implementation of the present disclosure. Please also refer to FIGS. 1, 2, and 3. The external information reception S1 further includes the following:

(1) Sensor initialization S11: The external device 11 undergoes an initialization process, and the external device 11 activates the plurality of external device sensors 111 (such as power supply monitors, mainboard hardware monitors, DC current sensors, DC voltage sensors, AC power meters, and various other types of sensors).

(2) USB port activation S12: The sensor connection port 1021 of the sensing interface card 102 is coupled to the plurality of external device sensors 111 of the external device 11, and the sensor connection port 1021 of the sensing interface card 102 is activated.

(3) External device sensor data reading S13: The sensing interface card 102 collects the plurality of detection values A data sensed by the plurality of external device sensors 111.

(4) Data transmission S14: The predictive maintenance program 103 instantly transmits the collected plurality of detection values A from the plurality of external device sensors 111 to the alert management interface G for displaying. During the transmission process, data is transmitted through the AES encryption mechanism.

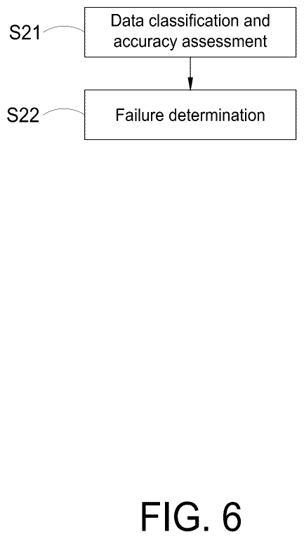

With reference to FIG. 6. FIG. 6 illustrates a flowchart of a comparative analysis in accordance with an example implementation of the present disclosure. The comparative analysis S2 further includes the following:

(5) Data classification and accuracy assessment S21: Classify the received plurality of detection values A that is transmitted by the plurality of external device sensors 111 and assess their accuracy. Data classification involves categorizing the sensing information of the sensor, such as fan speed, voltage, and current information. Accuracy assessment primarily involves determining whether the values of various data types that are preset in the system fall within the upper and lower limits that are set by the sensors. For example, determine whether the fan speed value is valid (by detecting whether the fan insertion signal exists), determine whether the voltage data is valid (by ensuring that the voltage reading falls between 0-24V), determine whether the current data is valid (by ensuring that the current reading falls between 0-10A and is non-negative).

(6) Failure determination S22: Perform failure prediction analysis on the plurality of detection values A that is sensed by the plurality of external device sensors 111.

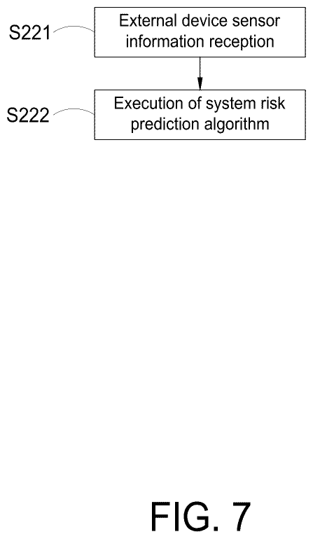

With reference to FIG. 7. FIG. 7 illustrates a flowchart of a failure determination in accordance with an example implementation of the present disclosure. Please also refer to FIGS. 1, 2, and 3. The failure determination S22 further includes the following:

(7) External device sensor information reception S221: The predictive maintenance system 10 may preset upper and lower limits for monitoring values. When the sensing interface card 102 receives the plurality of detection values A from the plurality of external device sensors 111, the sensing interface card 102 may instantly monitor whether these values exceed the preset upper and lower limits. If so, a warning will be issued to remind the user.

(8) Execution of system risk prediction algorithm S222: At fixed intervals, the received plurality of detection values A is input into the system risk prediction algorithm C that is stored in the storage 1011 for computation. The system risk prediction algorithm C is designed to consider the possibility of the external device being unable to operate safely. If the device replacement condition is triggered, a device abnormality alert is issued to remind the user to replace the device components.

With reference to FIGS. 1, 2, and 3. In some implementations, the failure prediction analysis result B is primarily categorized into three warning states, such as red light (abnormal), yellow light (caution), and green light (normal). These warning states may be displayed on the alert management interface G. When a red light or a yellow light warning state is triggered, the predictive maintenance program 103 will use the information transmission module 1032 to send out warning messages, alerts, or real-time social notifications, among other types of information.

In some implementations, the predictive maintenance system 10 of the present disclosure primarily receives the plurality of detection values A that is transmitted by the plurality of external device sensors 111 through the sensing interface card 102, then conducts preliminary analysis and calculations through the microprocessor 1022 in conjunction with the database 1023, thus effectively reducing the computational load on the entire system and being beneficial for accelerating the overall system processing speed. Subsequently, the predictive maintenance program 103 alerts the user about the health status of the external device. Therefore, the predictive maintenance system 10 of the present disclosure indeed achieves the goal of real-time monitoring of external devices and alerting users to the health status of these external devices.

The embodiments shown and described above are only examples. Many details are often found in the art. Therefore, many such details are neither shown nor described. Even though numerous characteristics and advantages of the present disclosure have been set forth in the foregoing description, together with details of the structure and function of the present disclosure, the present disclosure is illustrative only, and changes may be made in the details. It will therefore be appreciated that the embodiment described above may be modified within the scope of the claims.

What is claimed is:

1. A predictive maintenance system comprising:
a mainboard comprising:
a storage configured to store a computer program including instructions to be executed; and
one or more processors configured to execute the instructions of the computer program;
a sensing interface card coupled to the mainboard and comprising:
at least one sensor connection port configured to connect a plurality of external device sensors with different connection interfaces, and to receive a plurality of detection values detected by the plurality of external device sensors; and
a microprocessor configured to receive the plurality of detection values to generate a failure prediction analysis result; and
a predictive maintenance program including instructions that are stored in the storage, wherein when the instructions of the predictive maintenance program are executed by the one or more processors, the one or more processors are further configured to:
generate component service life information based on the failure prediction analysis result;
obtain warning information based on the component service life information;
display the warning information on an alert management interface through the mainboard.

2. The predictive maintenance system according to claim 1, wherein the storage further stores a system risk prediction algorithm, and the failure prediction analysis result is calculated and generated based on the plurality of detection values and the system risk prediction algorithm.

3. The predictive maintenance system according to claim 1, wherein the predictive maintenance program further comprises a plurality of component service life algorithms, and the component service life information is generated based on the failure prediction analysis result and the plurality of component service life algorithms.

4. The predictive maintenance system according to claim 1, wherein the predictive maintenance program further comprises an information transmission module configured to transmit the warning information through an email or an instant messaging system.

5. The predictive maintenance system according to claim 1, wherein the sensing interface card further comprises at least one environmental sensor, and the at least one environmental sensor is configured to sense various environmental parameter information inside a host where the sensing interface card is installed.

6. An implementation method of a predictive maintenance system comprising:
receiving external information, by at least one sensor connection port of a sensing interface card, comprising receiving a plurality of detection values of a plurality of external device sensors;
comparing and analyzing, by a microprocessor, the plurality of detection values and generating a failure prediction analysis result;
analyzing the failure prediction analysis result to determine and generate component service life information, generating warning information based on the component service life information, and displaying the warning information on an alert management interface, by a processor executing a predictive maintenance program including instructions; and
displaying, by an external monitoring device, the alert management interface through an internet connection, such that a health status of an external device is monitored through the alert management interface.

7. The implementation method according to claim 6, wherein the sensing interface card comprises a database, the database stores a plurality of component service life data, and the microprocessor further generates the failure prediction analysis result after comparing and analyzing the plurality of component service life data and the plurality of detection values.

8. The implementation method according to claim 6, wherein the sensing interface card comprises a plurality of environmental sensors, when the at least one sensor connection port of the sensing interface card receives the plurality of detection values of the plurality of external device sensors, the plurality of environment sensors simultaneously receive environmental parameter information inside a host where the sensing interface card is installed, and the sensing interface card further analyzes and compares the environmental parameter information and the plurality of detection values.

9. The implementation method according to claim 6, wherein the failure prediction analysis result is processed with a data security encryption and uploaded to a cloud server platform for a backup.

10. The implementation method according to claim 9, wherein the data security encryption is performed through an Advanced Encryption Standard (AES) encryption mechanism for data transmission.
